(19) United States
(12) Patent Application Publication
(10) Pub. No.: US 2025/0172860 A1
(43) Pub. Date: May 29, 2025

(54) BASE

(71) Applicant: DELTA ELECTRONICS, INC., Taoyuan City (TW)

(72) Inventors: Chun-Hao CHANG, Taoyuan City (TW); Yen-I CHOU, Taoyuan City (TW)

(21) Appl. No.: 18/438,444

(22) Filed: Feb. 10, 2024

(30) Foreign Application Priority Data
Nov. 24, 2023 (CN) 202311580741.7

(51) Int. Cl. G03B 21/16; G02B 26/00; G03B 21/20

(52) U.S. Cl. CPC G03B 21/16; G02B 26/008; G03B 21/204

(57) ABSTRACT

A base is applied in a wavelength conversion device. The base includes a first surface and a second surface. A plurality of first holes are formed on the first surface. The second surface and the first surface are respectively located on opposite sides of the base. A plurality of second holes are formed on the second surface. One of the first holes is communicated with at least one of the second holes. An edge of the at least one of the second holes laterally extends beyond an edge of the one of the first holes.

### CROSS-REFERENCE TO RELATED APPLICATION

This application claims priority to China Application Serial Number 202311580741.7, filed Nov. 24, 2023, which is herein incorporated by reference.

### BACKGROUND

### Technical Field

The present disclosure relates to a base, and more particularly, to a base applied in a wavelength conversion device.

### Description of Related Art

In recent years, optical projectors have been used in many fields, and the scope of applications has been expanding, from consumer products to high-tech equipment. Various optical projectors are also widely used in schools, homes, and commercial settings to amplify the display pattern provided by the signal source and display it on the projection screen.

For the light source configuration of an optical projector, it may use a solid-state laser light source to drive the fluorescent material to emit light. In this regard, the fluorescent material can be coated on the wheel, and a motor can be used to drive the wheel to cause it to rotate at high speed, thereby reducing the laser light source energy received by the fluorescent material per unit time and achieving the purpose of heat dissipation. However, as the brightness requirements of optical projectors continue to increase, the heat dissipation requirements for fluorescent materials are becoming increasingly stringent.

Accordingly, how to make the wheel and the fluorescent materials thereon have a better way of dissipating heat becomes an important issue to be solved by those in the industry.

### SUMMARY

An aspect of the disclosure is to provide a base to solve the foregoing problems.

According to an embodiment of the disclosure, a base is applied in a wavelength conversion device. The base includes a first surface and a second surface. A plurality of first holes are formed on the first surface. The second surface and the first surface are respectively located on opposite sides of the base. A plurality of second holes are formed on the second surface. One of the first holes is communicated with at least one of the second holes. An edge of the at least one of the second holes laterally extends beyond an edge of the one of the first holes.

In one or more embodiments of the present disclosure, a number of the at least one of the second holes is plural.

In one or more embodiments of the present disclosure, one of the second holes is communicated with at least one of the first holes. An edge of the at least one of the first holes laterally extends beyond an edge of the one of the second holes.

In one or more embodiments of the present disclosure, a number of the at least one of the first holes is plural.

In one or more embodiments of the present disclosure, a width of the first holes is substantially equal to a width of the second holes.

In one or more embodiments of the present disclosure, the first holes are regularly arranged on the first surface. The second holes are regularly arranged on the second surface.

In one or more embodiments of the present disclosure, the first holes are arranged on the first surface based on an array. The second holes are arranged on the second surface based on the array.

In one or more embodiments of the present disclosure, a depth of the first holes and a depth of the second holes are less than a thickness of the base.

In one or more embodiments of the present disclosure, a bottom of the one of the first holes and a bottom of the at least one of the second holes are between the first surface and the second surface.

In one or more embodiments of the present disclosure, the bottom of the one of the first holes is closer to the second surface than the bottom of the at least one of the second holes. The bottom of the at least one of the second holes is closer to the first surface than the bottom of the one of the first holes.

In one or more embodiments of the present disclosure, the base further includes a first substrate and a second substrate. The first holes run through the first substrate. The second holes run through the second substrate. The first surface is a surface of the first substrate away from the second substrate. The second surface is a surface of the second substrate away from the first substrate.

In one or more embodiments of the present disclosure, the base further includes a third substrate. The third substrate is stacked between the first substrate and the second substrate and has a plurality of through holes. The one of the first holes is communicated with the at least one of the second holes via at least one of the through holes.

In one or more embodiments of the present disclosure, the base further includes a third substrate. The second substrate is stacked between the first substrate and the third substrate. The third substrate has a plurality of through holes. One of the through holes is communicated with at least one of the second holes.

In one or more embodiments of the present disclosure, one of the first holes and one of the through holes are aligned in a stacking direction of the first substrate, the second substrate, and the third substrate.

According to an embodiment of the disclosure, a base includes is applied in a wavelength conversion device. The base includes a first surface and a second surface. A plurality of first holes are formed on the first surface. The second surface and the first surface are respectively located on opposite sides of the base. A plurality of second holes are formed on the second surface. One of the first holes is communicated with at least one of the second holes. The one of the first holes and the at least one of the second holes are laterally offset in a direction parallel to the first surface or the second surface.

Accordingly, in the base of the present disclosure, the first hole on the first surface and the second hole on the second surface are communicated with each other and laterally offset. Thus, the base of the present disclosure can at least achieve the following advantages: (1) It can increase the specific surface area (SSA) of the base, thereby increasing the overall heat dissipation area; (2) Reduce the overall weight of the base, thereby slowing down the load power of the motor; and (3) staggered holes can increase the structural rigidity of the base, thereby stably increasing the rotation speed and improving cavity airflow operation.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a front view of a base according to an embodiment of the present disclosure;

FIG. 2 is a cross-sectional view of the base in FIG. 1 taken along line 2-2;

FIG. 3 is a front view of a base according to an embodiment of the present disclosure;

FIG. 4 is a cross-sectional view of the base in FIG. 3 taken along line 4-4;

FIG. 5 is a front view of a base according to an embodiment of the present disclosure;

FIG. 6 is a cross-sectional view of the base in FIG. 5 taken along line 6-6;

FIG. 7 is a front view of a base according to an embodiment of the present disclosure;

FIG. 8 is a cross-sectional view of the base in FIG. 7 taken along line 8-8;

FIG. 9 is a front view of a conventional base;

FIG. 10 is a graph showing curves of power of light source power vs. brightness of different embodiments of the base of the present disclosure and the conventional base; and

FIG. 11 is a graph showing curves of power of light source power vs. temperature of the different embodiments of the base of the present disclosure and the conventional base.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

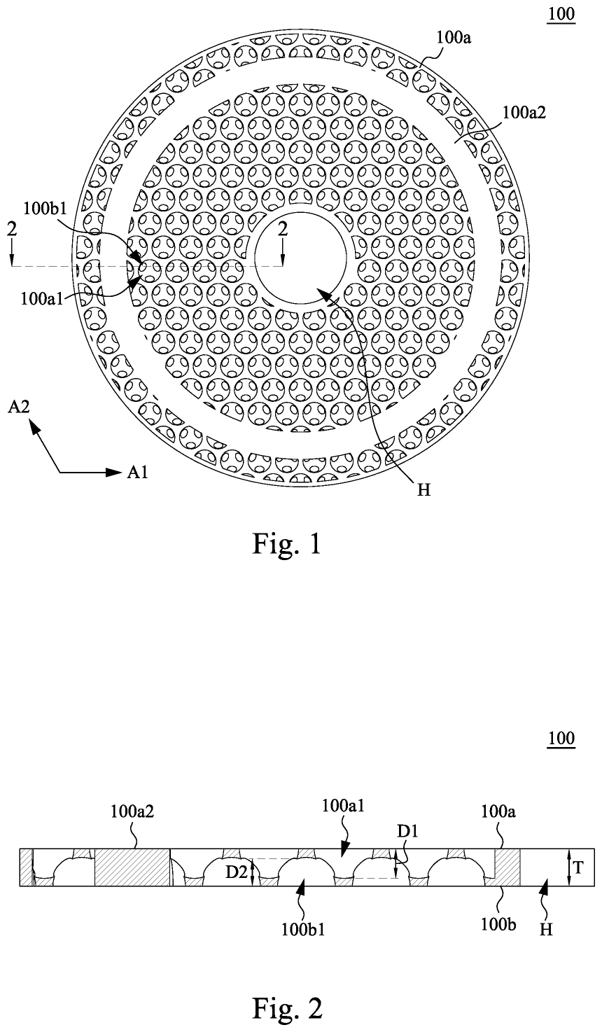

Reference is made to FIGS. 1 and 2. FIG. 1 is a front view of a base 100 according to an embodiment of the present disclosure. FIG. 2 is a cross-sectional view of the base 100 in FIG. 1 taken along line 2-2. As shown in FIGS. 1 and 2, in the present embodiment, the base 100 may be applied to a wavelength conversion device (not shown). For example, the wavelength conversion device is a fluorescent wheel used in a projection device (not shown). The projection device may further include a driving unit and a light source. The base 100 has a shaft hole H. The driving unit is, for example, a motor, and the rotating shaft of the motor is engaged with the inner edge of the shaft hole H. By rotating the rotating shaft of the motor, the wavelength conversion device can be driven to rotate. The light source is configured to emit light and form a light spot that is fixedly illuminated on the base 100. In some embodiments, the light source is a solid-state laser light source, but the disclosure is not limited thereto.

The wavelength conversion device further includes a phosphor layer (not shown). The phosphor layer is disposed on the base 100 and configured to receive the light emitted by the light source. Specifically, the light emitted by the light source can reach the phosphor layer through a specially designed light path (for example, a reflector, a beam splitter, etc.), and generate the light spot on the phosphor layer. As shown in FIGS. 1 and 2, the base 100 includes a first surface 100a. The first surface 100a has a disposing area 100a2. The disposing area 100a2 extends substantially along a circular path. The phosphor layer is disposed on the disposing area 100a2, so the phosphor layer can also be disposed on the base 100 along the circular path. In this way, when the base 100 rotates, the light spot generated by the light source can continuously illuminate the phosphor layer.

As shown in FIGS. 1 and 2, in the present embodiment, a plurality of first holes 100a1 are formed on the first surface 100a of the base 100. The base 100 further includes a second surface 100b. The second surface 100b and the first surface 100a are respectively located on opposite sides of the base 100. A plurality of second holes 100b1 are formed on the second surface 100b. One of the first holes 100a1 is communicated with at least one of the second holes 100b1. An edge of the at least one of the second holes 100b1 laterally extends beyond an edge of the one of the first holes 100a1. In other words, the first hole 100a1 on the first surface 100a and the second hole 100b1 on the second surface 100b are communicated with each other and laterally offset.

Through the aforementioned structural configurations, the base 100 of the present embodiment can at least achieve the following advantages: (1) It can increase the specific surface area (SSA) of the base 100, thereby increasing the overall heat dissipation area; (2) Reduce the overall weight of the base 100, thereby slowing down the load power of the motor; and (3) the staggered first holes 100a1 and the second holes 100b1 can increase the structural rigidity of the base 100, thereby stably increasing the rotation speed and improving cavity airflow operation. It should be noted that the aforementioned SSA refers to a total surface area possessed by the base 100 within unit mass.

In some embodiments, the SSA of the base 100 is greater than its geometric area by more than 20%, but the disclosure is not limited thereto. The aforementioned geometric area refers to a total area of the base 100 without the first holes 100a1 and the second holes 100b1. The geometric area can be obtained by summing the orthographic projected areas of all surfaces of the base 100.

In some embodiments, the overall weight of the base 100 having the first holes 100a1 and the second holes 100b1 can be reduced by about 5% to about 60%, but the disclosure is not limited thereto.

As shown in FIG. 1, the one of the first holes 100a1 is communicated with three of the second holes 100b1, but the present disclosure is not limited thereto. In practical applications, the number of second holes 100b1 that are simultaneously communicated with the one of the first holes 100a1 can be flexibly increased or decreased.

In practical applications, the group number of structures each having a first hole 100a1 communicated with a plurality of the second holes 100b1 is plural, as shown in FIGS. 1 and 2.

As shown in FIG. 2, in the present embodiment, one of the second holes 100b1 is communicated with at least one of the first holes 100a1. An edge of the at least one of the first holes 100a1 laterally extends beyond an edge of the one of the second holes 100b1. For example, the one of the second holes 100b1 may be communicated with three of the first holes 100a1, but the present disclosure is not limited thereto. In practical applications, the number of first holes 100a1 that are simultaneously communicated with the one of the second holes 100b1 can be flexibly increased or decreased.

In practical applications, the group number of structures each having a second hole 100b1 communicated with a plurality of the first holes 100a1 is plural, as shown in FIG. 2.

In practical applications, by making each of the first holes 100a1 be communicated with a plurality of the second holes 100b1 and laterally offset, and at the same time making each of the second holes 100b1 be communicated with a plurality of the first holes 100a1 and laterally offset, the aforementioned advantages can be achieved more significant.

In some embodiments, a width of the first holes 100a1 is substantially equal to a width of the second holes 100b1. For example, the first holes 100a1 and the second holes 100b1 are circular holes and have substantially the same hole diameter. Hence, the first holes 100a1 and the second holes 100b1 can be made by using the same tool, so the manufacturing cost can be reduced.

In some embodiments, the first holes 100a1 are regularly arranged on the first surface 100a. For example, the first holes 100a1 are arranged on the first surface 100a based on an array. The array consists of a first dimension A1 and a second dimension A2. That is, the first holes 100a1 are arranged along the first dimension A1 and the second dimension A2 at the same time.

In some embodiments, the second holes 100b1 are regularly arranged on the second surface 100b. For example, the second holes 100b1 are arranged on the second surface 100b based on the foregoing array. In other words, when looking directly at the first surface 100a and the second surface 100b, the pattern arranged by the first holes 100a1 is the same as the pattern arranged by the second holes 100b1, and the two patterns can coincide by rotation. Therefore, the second holes 100b1 on the second surface 100b can be made in the same manner as the first holes 100a1 on the first surface 100a, thereby simplifying the manufacturing difficulty and reducing the manufacturing cost.

As shown in FIG. 2, in the present embodiment, a depth D1 of the first holes 100a1 and a depth D2 of the second holes 100b1 are less than a thickness T of the base 100. In the actual manufacturing process, the first holes 100a1 can be dug along a direction perpendicular to the first surface 100a, and the first holes 100a1 do not run through the base 100. Then, the second holes 100b1 can be dug along a direction perpendicular to the second surface 100b, such that each of the first holes 100a1 is communicated with at least one of the second holes 100b1 and/or each of the second holes 100b1 is communicated with at least one of the first holes 100a1, thereby completing the production of the base 100. In other words, the first holes 100a1 and the second holes 100b1 are laterally offset and do not coincide in a direction perpendicular to the first surface 100a or the second surface 100b, and therefore can have the aforementioned advantages compared with a design with a single hole directly running through.

In some embodiments, the thickness T of the base 100 ranges from about 0.5 mm to about 50 mm, but the present disclosure is not limited thereto.

In some embodiments, the porosity of the base 100 ranges from about 5% to about 75%, but the disclosure is not limited thereto.

In some embodiments, the base 100 which is reflective and opaque includes a metal material. The metal material includes, for example, Al, Ag, Cu, Fe, Mo, or combinations thereof, but the present disclosure is not limited thereto.

In some embodiments, the base 100 which is reflective and opaque includes a ceramic material. The ceramic material includes, for example, AlN, BN, SiC, or Al₂O₃, but the present disclosure is not limited thereto.

In some embodiments, the base 100 which is reflective and opaque includes a semiconductor material. The semiconductor material includes, for example, a unit semiconductor material (e.g., Si, Ge), a binary semiconductor material (e.g., GaAs, InP, GaN, InAs, ZnSe, ZnS, InSe, etc.), or other series of materials such as multiple compound semiconductors of binary or higher, but the present disclosure is not limited thereto.

In some embodiments, a material of the base 100 which is transparent includes glass, quartz, sapphire, or CaF₂, but the present disclosure is not limited thereto.

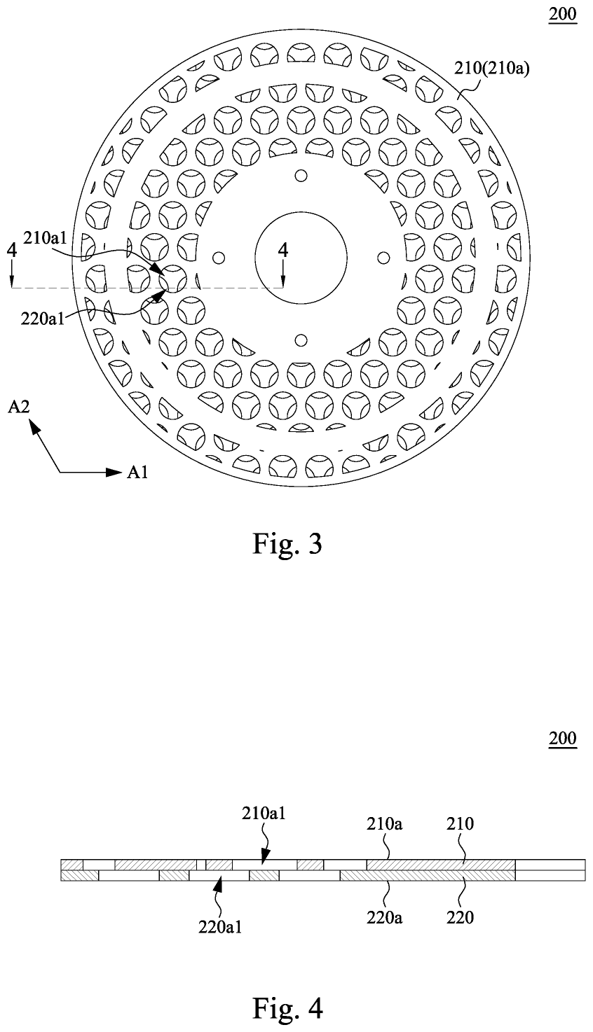

Reference is made to FIGS. 3 and 4. FIG. 3 is a front view of a base 200 according to an embodiment of the present disclosure. FIG. 4 is a cross-sectional view of the base 200 in FIG. 3 taken along line 4-4. As shown in FIGS. 3 and 4, in the present embodiment, the base 200 includes a first substrate 210 and a second substrate 220. The first substrate 210 has a first surface 210a away from the second substrate 220 and first holes 210a1 running through the first substrate 210. The second substrate 220 has a second surface 220a away from the first substrate 210 and second holes 220a1 running through the second substrate 220. One of the first holes 210a1 is communicated with at least one of the second holes 220a1. An edge of the at least one of the second holes 220a1 laterally extends beyond an edge of the one of the first holes 210a1. In other words, the first hole 210a1 on the first surface 210a and the second hole 220a1 on the second surface 220a are communicated with each other and laterally offset. With such structural configurations, the base 200 of the present embodiment can also achieve at least the aforementioned advantages.

As shown in FIG. 3, the one of the first holes 210a1 is communicated with three of the second holes 220a1, but the present disclosure is not limited thereto. In practical applications, the number of second holes 220a1 that are simultaneously communicated with the one of the first holes 210a1 can be flexibly increased or decreased.

In practical applications, the group number of structures each having a first hole 210a1 communicated with a plurality of the second holes 220a1 is plural, as shown in FIGS. 3 and 4.

As shown in FIG. 4, in the present embodiment, one of the second holes 220a1 is communicated with at least one of the first holes 210a1. An edge of the at least one of the first holes 210a1 laterally extends beyond an edge of the one of the second holes 220a1. For example, the one of the second holes 220a1 may be communicated with three of the first holes 210a1, but the present disclosure is not limited thereto. In practical applications, the number of first holes 210a1 that are simultaneously communicated with the one of the second holes 220a1 can be flexibly increased or decreased.

In practical applications, the group number of structures each having a second hole 220a1 communicated with a plurality of the first holes 210a1 is plural, as shown in FIG. 4.

In practical applications, by making each of the first holes 210a1 be communicated with a plurality of the second holes 220a1 and laterally offset, and at the same time making each of the second holes 220a1 be communicated with a plurality of the first holes 210a1 and laterally offset, the aforementioned advantages can be achieved more significant.

In some embodiments, a width of the first holes 210a1 is substantially equal to a width of the second holes 220a1. For example, the first holes 210a1 and the second holes 220a1 are circular holes and have substantially the same hole diameter. Hence, the first holes 210a1 and the second holes 220a1 can be made by using the same tool, so the manufacturing cost can be reduced.

In some embodiments, the first holes 210a1 are regularly arranged on the first surface 210a. For example, the first holes 210a1 are arranged on the first surface 210a based on an array. The array consists of the first dimension A1 and the second dimension A2. That is, the first holes 210a1 are arranged along the first dimension A1 and the second dimension A2 at the same time.

In some embodiments, the second holes 220a1 are regularly arranged on the second surface 220a. For example, the second holes 220a1 are arranged on the second surface 220a based on the foregoing array. In other words, when looking directly at the first surface 210a and the second surface 220a, the pattern arranged by the first holes 210a1 is the same as the pattern arranged by the second holes 220a1, and the two patterns can coincide by rotation. Therefore, the second holes 220a1 on the second surface 220a can be made in the same manner as the first holes 210a1 on the first surface 210a, thereby simplifying the manufacturing difficulty and reducing the manufacturing cost.

In the actual manufacturing process, the first holes 210a1 can be dug to run through the first substrate 210, and the second holes 220a1 can be dug to run through the second substrate 220. Then, the first substrate 210 and the second substrate 220 are stacked, such that each of the first holes 210a1 is communicated with at least one of the second holes 220a1 and/or each of the second holes 220a1 is communicated with at least one of the first holes 210a1, thereby completing the production of the base 200.

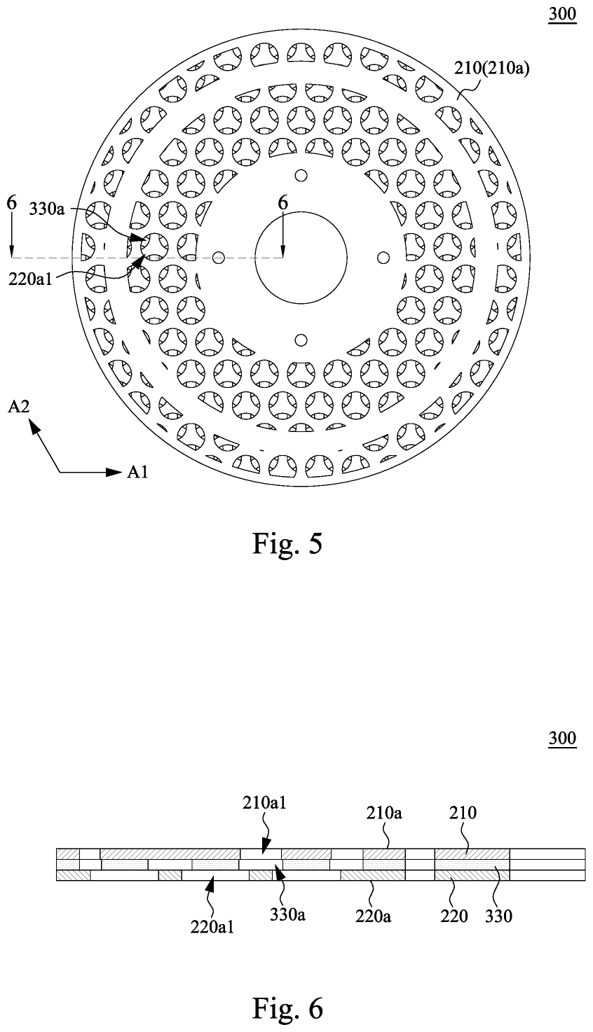

Reference is made to FIGS. 5 and 6. FIG. 5 is a front view of a base 300 according to an embodiment of the present disclosure. FIG. 6 is a cross-sectional view of the base 300 in FIG. 5 taken along line 6-6. As shown in FIGS. 5 and 6, in the present embodiment, the base 300 includes a first substrate 210, a second substrate 220, and a third substrate 330. The first substrate 210 and the second substrate 220 are the same as those of the embodiment shown in FIG. 3, so they can be referred to the above related descriptions and will not go into details here. Specifically, in the present embodiment, the third substrate 330 is stacked between the first substrate 210 and the second substrate 220 and has a plurality of through holes 330a. One of the first holes 210a1 is communicated with at least one of the second holes 220a1 via at least one of the through holes 330a. With such structural configurations, the base 300 of the present embodiment can also achieve at least the aforementioned advantages.

As shown in FIGS. 5 and 6, an edge of the at least one of the through holes 330a laterally extends beyond an edge of the one of the first holes 210a1. In other words, the first hole 210a1 of the first substrate 210 and the through holes 330a of the third substrate 330 are communicated with each other and laterally offset. In this way, the aforementioned advantages can be achieved more significant.

As shown in FIG. 5, the one of the first holes 210a1 is communicated with three of the through holes 330a, but the present disclosure is not limited thereto. In practical applications, the number of through holes 330a that are simultaneously communicated with the one of the first holes 210a1 can be flexibly increased or decreased.

In practical applications, the group number of structures each having a first hole 210a1 communicated with a plurality of the through holes 330a is plural, as shown in FIG. 5.

In the present embodiment, one of the second holes 220a1 is communicated with at least one of the through holes 330a. An edge of the at least one of the through holes 330a laterally extends beyond an edge of the one of the second holes 220a1. For example, the one of the second holes 220a1 may be communicated with three of the through holes 330a, but the present disclosure is not limited thereto. In other words, the second hole 220a1 of the second substrate 220 and the through holes 330a of the third substrate 330 are communicated with each other and laterally offset. In this way, the aforementioned advantages can be achieved more significant.

In practical applications, the number of through holes 330a that are simultaneously communicated with the one of the second holes 220a1 can be flexibly increased or decreased.

In the actual manufacturing process, the first holes 210a1 can be dug to run through the first substrate 210, the second holes 220a1 can be dug to run through the second substrate 220, and the through holes 330a can be dug to run through the third substrate 330. Then, the third substrate 330 is stacked between the first substrate 210 and the second substrate 220, such that each of the first holes 210a1 is communicated with at least one of the second holes 220a1 via at least one of the through holes 330a and/or each of the second holes 220a1 is communicated with at least one of the first holes 210a1 via at least one of the through holes 330a, thereby completing the production of the base 300.

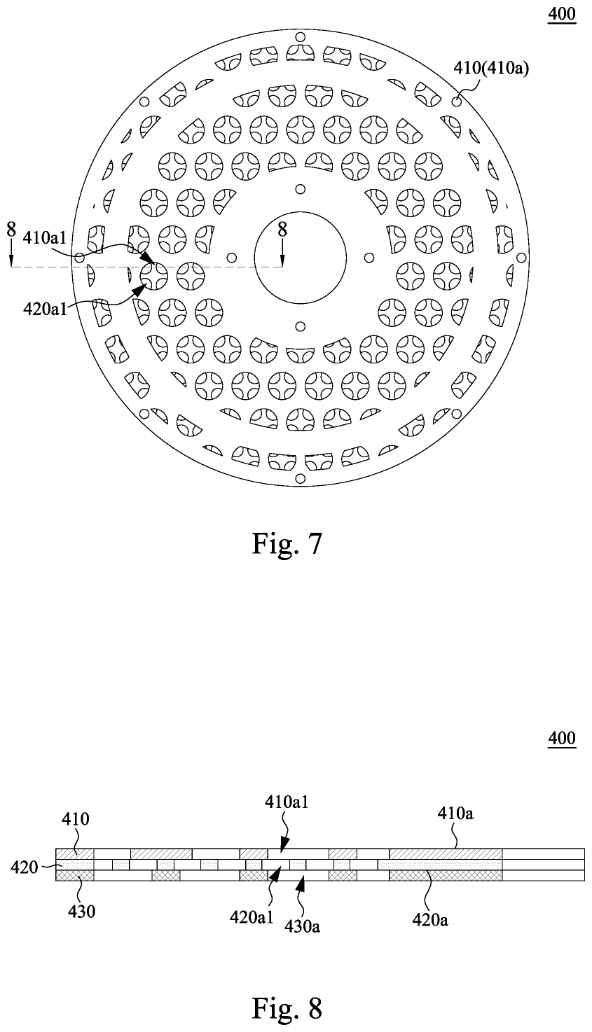

Reference is made to FIGS. 7 and 8. FIG. 7 is a front view of a base 400 according to an embodiment of the present disclosure. FIG. 8 is a cross-sectional view of the base 400 in FIG. 7 taken along line 8-8. As shown in FIGS. 7 and 8, in the present embodiment, the base 400 includes a first substrate 410, a second substrate 420, and a third substrate 430. The first substrate 410 has a first surface 410a away from the second substrate 420 and first holes 410a1 running through the first substrate 410. The second substrate 420 has a second surface 420a away from the first substrate 410 and second holes 420a1 running through the second substrate 420. The first substrate 410 and the second substrate 420 are similar to the first substrate 210 and the second substrate 220 of the embodiment shown in FIG. 3, so they can be referred to the above related descriptions and will not go into details here. One difference of the combination of the first substrate 410 and the second substrate 420 of the present embodiment compared with the embodiment shown in FIG. 3 is that one of the first holes 410a1 is communicated with four of the second holes 420a1 in the present embodiment, but the present disclosure is not limited thereto.

As shown in FIG. 8, in the present embodiment, the second substrate 420 is stacked between the first substrate 410 and the third substrate 430. The third substrate 430 has a plurality of through holes 430a. One of the through holes 430a is communicated with at least one of the second holes 420a1. An edge of at least one of the second holes 420a1 laterally extends beyond an edge of the one of the through holes 430a. In other words, the through hole 430a of the third substrate 430 and the second hole 420a1 of the second substrate 420 are communicated with each other and laterally offset. In this way, the aforementioned advantages can be achieved more significant.

In practical applications, the one of the through holes 430a is communicated with a plurality of the second holes 420a1, and the number of second holes 420a1 that are simultaneously communicated with the one of the through holes 430a can be flexibly increased or decreased.

In practical applications, the group number of structures each having a through hole 430a communicated with a plurality of the second holes 420a1 is plural, as shown in FIG. 8.

In one embodiment, one of the first holes 410a1 and one of the through holes 430a are aligned in a stacking direction of the first substrate 410, the second substrate 420, and the third substrate 430. For example, as shown in FIGS. 7 and 8, all of the first holes 410a1 and all of the through holes 430a respectively correspond to each other in the stacking direction of the first substrate 410, the second substrate 420, and the third substrate 430.

In the actual manufacturing process, the first holes 410a1 can be dug to run through the first substrate 410, the second holes 420a1 can be dug to run through the second substrate 420, and the through holes 430a can be dug to run through the third substrate 430. Then, the second substrate 420 is stacked between the first substrate 410 and the third substrate 430, such that each of the first holes 410a1 is communicated with one of the through holes 430a via at least one of the second holes 420a1, thereby completing the production of the base 400.

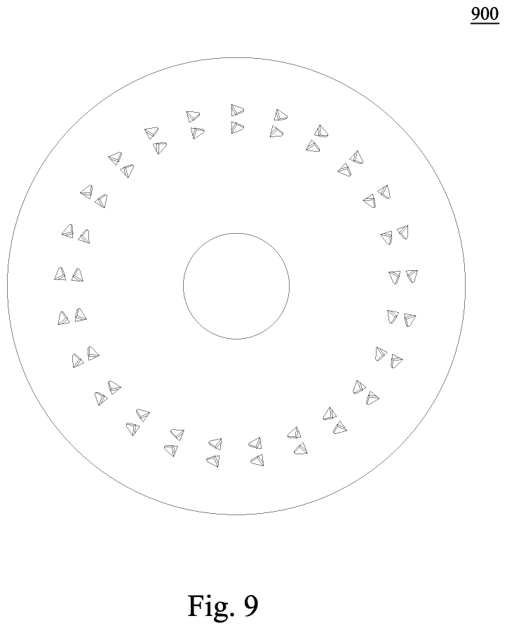

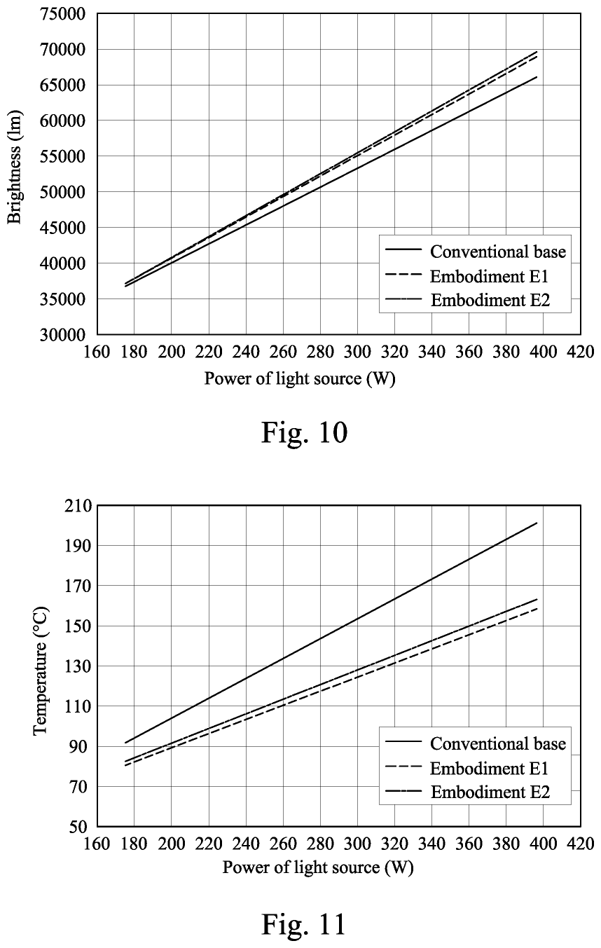

Reference is made to FIGS. 9 to 11. FIG. 9 is a front view of a conventional base 900. FIG. 10 is a graph showing curves of power of light source power vs. brightness of different embodiments of the base of the present disclosure and the conventional base 900. FIG. 11 is a graph showing curves of power of light source power vs. temperature of the different embodiments of the base of the present disclosure and the conventional base 900. As shown in FIG. 9, the conventional base 900 has a plurality of arrow-shaped holes. For comparison with a conventional wavelength conversion device, in FIGS. 10 and 11, the embodiment E1 using the base 100 shown in FIG. 1 and the embodiment E2 using the base 200 shown in FIG. 3 are used for actual testing. Furthermore, the curves in FIGS. 10 and 11 are measured using the conventional wavelength conversion device and the embodiments E1 and E2 under the same rotational speed conditions.

It can be clearly seen from FIG. 10 that for each of the embodiments E1 and E2, the brightness of the phosphor layer (i.e., luminous efficiency) does not deteriorate drastically as the light source power increases (i.e., there is no thermal decay phenomenon). Therefore, for the projection devices using the embodiments E1 and E2, at the highest light source power of 396 W, the brightness can be significantly increased by about 5% compared with the conventional wavelength conversion device. In addition, it can be clearly seen from FIG. 11 that the temperature measured at the light spot of each of the embodiments E1 and E2 is at least 40° C. lower than the temperature at the light spot of the conventional wavelength conversion device. Therefore, the thermal decay of the phosphor layer due to high temperature can be effectively avoided.

According to the foregoing recitations of the embodiments of the disclosure, it can be seen that in the base of the present disclosure, the first hole on the first surface and the second hole on the second surface are communicated with each other and laterally offset. Thus, the base of the present disclosure can at least achieve the following advantages: (1) It can increase the SSA of the base, thereby increasing the overall heat dissipation area; (2) Reduce the overall weight of the base, thereby slowing down the load power of the motor; and (3) staggered holes can increase the structural rigidity of the base, thereby stably increasing the rotation speed and improving cavity airflow operation.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A base applied in a wavelength conversion device, the base comprising:
a first surface, a plurality of first holes being formed on the first surface; and
a second surface, the second surface and the first surface being respectively located on opposite sides of the base, a plurality of second holes being formed on the second surface;
wherein one of the first holes is communicated with at least one of the second holes, and an edge of the at least one of the second holes laterally extends beyond an edge of the one of the first holes.

2. The base of claim 1, wherein a number of the at least one of the second holes is plural.

3. The base of claim 1, wherein one of the second holes is communicated with at least one of the first holes, and an edge of the at least one of the first holes laterally extends beyond an edge of the one of the second holes.

4. The base of claim 3, wherein a number of the at least one of the first holes is plural.

5. The base of claim 1, wherein a width of the first holes is substantially equal to a width of the second holes.

6. The base of claim 1, wherein the first holes are regularly arranged on the first surface, and the second holes are regularly arranged on the second surface.

7. The base of claim 6, wherein the first holes are arranged on the first surface based on an array, and the second holes are arranged on the second surface based on the array.

8. The base of claim 1, wherein a depth of the first holes and a depth of the second holes are less than a thickness of the base.

9. The base of claim 1, wherein a bottom of the one of the first holes and a bottom of the at least one of the second holes are between the first surface and the second surface.

10. The base of claim 9, wherein the bottom of the one of the first holes is closer to the second surface than the bottom of the at least one of the second holes, and the bottom of the at least one of the second holes is closer to the first surface than the bottom of the one of the first holes.

11. The base of claim 1, further comprising:
a first substrate, wherein the first holes run through the first substrate; and
a second substrate, wherein the second holes run through the second substrate,
wherein the first surface is a surface of the first substrate away from the second substrate, and the second surface is a surface of the second substrate away from the first substrate.

12. The base of claim 11, further comprising a third substrate, wherein the third substrate is stacked between the first substrate and the second substrate and has a plurality of through holes, and the one of the first holes is communicated with the at least one of the second holes via at least one of the through holes.

13. The base of claim 11, further comprising a third substrate, wherein the second substrate is stacked between the first substrate and the third substrate, the third substrate has a plurality of through holes, and one of the through holes is communicated with at least one of the second holes.

14. The base of claim 13, wherein one of the first holes and one of the through holes are aligned in a stacking direction of the first substrate, the second substrate, and the third substrate.

15. A base applied in a wavelength conversion device, the base comprising:
a first surface, a plurality of first holes being formed on the first surface; and
a second surface, the second surface and the first surface being respectively located on opposite sides of the base with the first surface, a plurality of second holes being formed on the second surface;
wherein one of the first holes is communicated with at least one of the second holes, and the one of the first holes and the at least one of the second holes are laterally offset in a direction parallel to the first surface or the second surface.
